(19) United States
(12) Patent Application Publication
(10) Pub. No.: US 2008/0213528 A1
(43) Pub. Date: Sep. 4, 2008

(54) Customized printing with depth effect

(76) Inventor: Anthony L. Hoffman, Eagan, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/004,097

(22) Filed: Dec. 19, 2007

Related U.S. Application Data
(60) Provisional application No. 60/875,641, filed on Dec. 19, 2006.

(51) Int. Cl. B32B 9/00

(52) U.S. Cl. 428/42.1

(57) ABSTRACT

A moiré pattern display sheet defined by a surface is described. A first layer has a pattern printed thereon. The pattern includes a series of visual elements in a first row that have been distorted at least in a first direction. The series of visual elements is generated from an electronically saved file of vector based graphics. A light steering optical layer overlaying the first layer. The light steering optical layer comprising a plurality of optical features which change the direction of the light and thereby provide a depth effect of the series of visual elements to a viewer looking through the light steering optical layer.

### REFERENCE TO RELATED APPLICATIONS

This application claims priority to U.S. provisional application No. 60/875,641, filed Dec. 19, 2006, entitled “CUSTOMIZED PRINTING WITH DEPTH EFFECT,” which herein incorporated by reference in its entirety.

### BACKGROUND

The invention generally relates to applications and techniques of moiré pattern display sheets which create a visual layered image effect when combined with personalized or customized images and which may be used as notebooks, notepads, binders, sketchbooks, gift cards, business cards, greeting cards, invitations, scrapbooks, among other uses.

It is conventionally known to create images with depth effects using lenticular screens and lenticular imaging techniques. Such lenticular products are not easily customized by a user with customized or personalized images because alignment of the lenticular lens screen and the lenticular image must be done carefully to produce a desirable end result. Such careful alignment may not be possible by an end-user who wishes to have their own customized or personalized image have a depth effect.

It is also conventionally known to create display sheets which may be used for labeling, decoration, advertising, etc. that provide a visual effect of depth using interferometric effects. The interferometric visual effect provides a pattern which appears to be in back of or in front of another image. This depth effect may also be referred to as a layered image effect. Such a layered image effect may be produced by using a series of images that are distorted in one direction (e.g. distorted in the width). The effect is created by overlaying a lenticular lens screen which steers light thereby producing the depth effect of the series images. The alignment of the lenticular lens screen is much more forgiving than with conventional lenticular displays. A static or a focal image may interrupt and overlay the series of images. The static or the focal image may be a plain image, an interlaced image, or other types of images.

This technique may be referred to as the creation of moiré patterns which is an interferometric effect.

Conventional applications and techniques of moiré pattern layered image creation have been very limited. Accordingly, there is a need for new or improved applications of moiré pattern technology in which personalized or customized information may be placed in a moiré image by an end-user.

The techniques herein below extend to those embodiments which fall within the scope of the appended claims, regardless of whether they accomplish one or more of the above-mentioned needs.

### SUMMARY

What is provided is a personalized image with a depth effect. The image comprises a first layer having a pre-printed moiré pattern printed thereon. The pre-printed moiré pattern includes a series of pattern elements at least some of which have been distorted at least in a first direction. The image also comprises a customized or personalized image that is at least one of coupled to, overlying, or underlying the first layer. The image further comprises a light steering optical layer overlying the first layer. The light steering optical layer includes a plurality of optical features which change the direction of the light and thereby provide a depth effect of the customized or personalized image and a pattern image.

What is also provided is a method of customizing an image having a depth effect. The method comprises printing a first layer with a moiré pattern. The moiré pattern includes a series of pattern elements that have been distorted at least in a first direction. The method further comprises providing a customized or personalized image to at least one of overlie, underlie, or couple to the first layer. Further still, the method comprises providing a light steering optical layer overlying the customized or personalized image. The light steering optical layer includes a plurality of optical features which change the direction of the light and thereby provide a depth effect of the customized or personalized image and a pattern image.

Further, what is provided is a depth effect customization kit. The kit comprises a first layer having a pre-printed moiré pattern printed thereon. The pre-printed moiré pattern includes a series of pattern elements that have been distorted at least in a first direction. The kit also comprises a means to provide a customized or personalized image that is at least one of coupled to, overlying, or underlying the first layer. Further, the kit comprises a light steering optical layer overlying the first layer. Further, the light steering optical layer comprises a plurality of optical features which change the direction of the light and thereby provide a depth effect of the customized or personalized image and a pattern image.

Alternative exemplary embodiments relate to other features and combinations of features as may be generally recited in the claims.

### BRIEF DESCRIPTION OF THE DRAWINGS

A better understanding of the features and advantages of the present invention will be obtained by reference to the following detailed description that sets forth illustrative embodiments by way of example only, in which the principles of the invention are utilized, and the accompanying drawings, of which:

FIG. 1 is an exemplary cross sectional diagram of a lenticular lens sheet overlaying a printed layer, the structure configured to produce a layered image effect.

FIG. 2 is an exemplary depiction of a resultant display sheet having a layered image effect.

FIG. 3 is an exemplary diagram of a distorted pattern used to produce the layered image effect.

FIG. 4 is an exemplary diagram of a background pattern in accordance with an exemplary embodiment.

FIG. 5 is an exemplary diagram of a customized image production system.

FIG. 6 is an exemplary process diagram of a customized image creation process.

FIG. 7 is an exemplary diagram of an embodiment of an image with depth effect customization kit.

FIG. 8 is an exemplary diagram of an exemplary embodiment of a paper pad with a lens cover.

FIG. 9 is an exemplary diagram of a customized image with a lens sleeve.

FIG. 10 is an exemplary diagram of a binder with a lens overlay.

### DETAILED DESCRIPTION

Before describing in detail the particular improved display sheet and method, it should be observed that the invention includes, but is not limited to a novel structural combination of conventional components and optical sheets, and not in the particular detailed configurations thereof. Accordingly, the structure and methods for the most part, have been illustrated in the drawings by readily understandable block representations and schematic diagrams, in order not to obscure the disclosure with structural details which will be readily apparent to those skilled in the art, having the benefit of the description herein. Further, the invention is not limited to the particular embodiments depicted in the exemplary diagrams, but should be construed in accordance with the language in the claims.

Subject matter related to that disclosed herein is disclosed in U.S. Application No. 60/852,098, entitled “SYSTEM AND METHOD FOR PROVIDING CUSTOMIZED LENTICULAR DISPLAY PRODUCTS,” filed Oct. 16, 2006 which is herein incorporated by reference; U.S. Application No. 60/848,719, entitled “LAYERED IMAGE DISPLAY SHEET,” filed Oct. 2, 2006 which is herein incorporated by reference; and U.S. Application No. 60/848,728, entitled “LAYERED IMAGE DISPLAY APPLICATIONS AND METHODS,” filed Oct. 2, 2006 which is herein incorporated by reference.

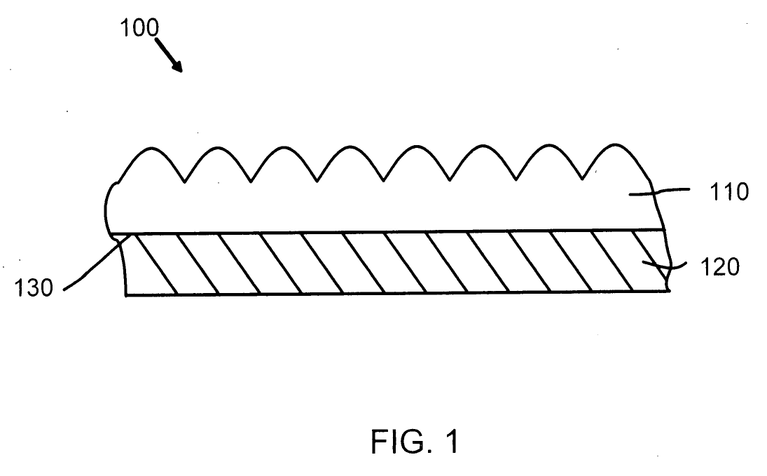

Referring now to FIG. 1, FIG. 1 illustrates a cross section of a moiré pattern and depth effect generating system 100. The system 100 includes a lenticular lens 110 in accordance with the invention. The lenticular lens top sheet 110 can be formed from a variety of materials, including but not limited to, a clear plastic sheet, a polyvinyl chloride (PVC) sheet, an amorphous polyethylene terephthalate (APET). A sheet 120, for example, an organic surface or a synthetic surface, such as a sheet of paper, cardstock, plastic, film, glass, foil, or any other type of substrate, may have a moiré pattern printed thereon with a customized or personalized image. The customized or personalized image may be coupled to sheet 120, by printing, adhering, depositing, placing, etc. the image, or may be similarly coupled to a surface 130 or lenticular lens sheet 110. Further, lenticular lens sheet 110 may be an overlay for an electronic display screen, such as but not limited to a liquid crystal display (LED) or other type of electronic display device. Also, the lenticular lens or other lens sheet may be incorporated into the electronic display device as a layer of the electronic display device. In yet another exemplary embodiment, the moiré pattern may be printed on the backside of the lenticular lens sheet. Further still, the customized image may be printed directly to the backside of the lens sheet either alone or along with the moiré pattern.

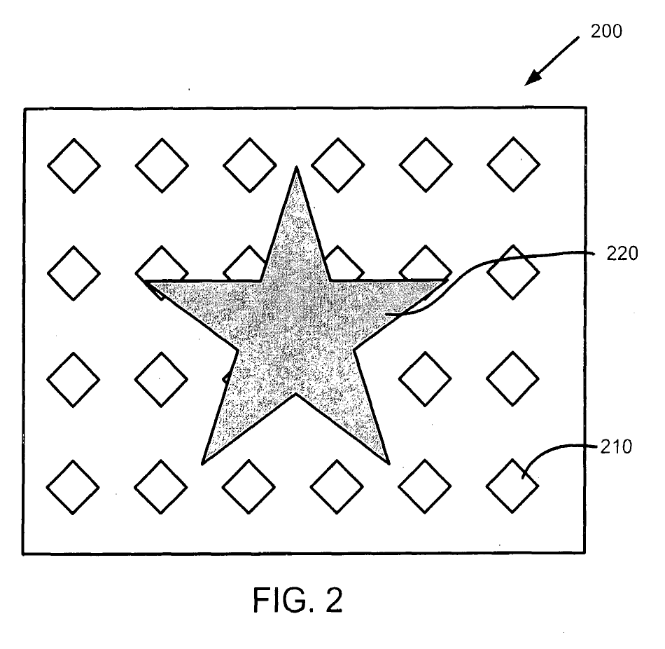

Referring now to FIG. 2, a display sheet 200 having a background pattern image 210 with a focal image 220 is depicted. Background pattern image 210 is a moiré pattern having a depth effect when coupled with a light steering optical element such as but not limited to a lenticular lens sheet. Focal image 220 may be a conventional flat image or may be an interlaced image providing motion, flips, three-dimensional effects, or other effects as may be conventionally created with a lenticular lens screen. More particularly, focal image 220 may be a customized or personalized image that is printed or otherwise positioned as shown by a user of the sheet. Background pattern image 210 may also be configured as a foreground image without departing from the scope of the invention.

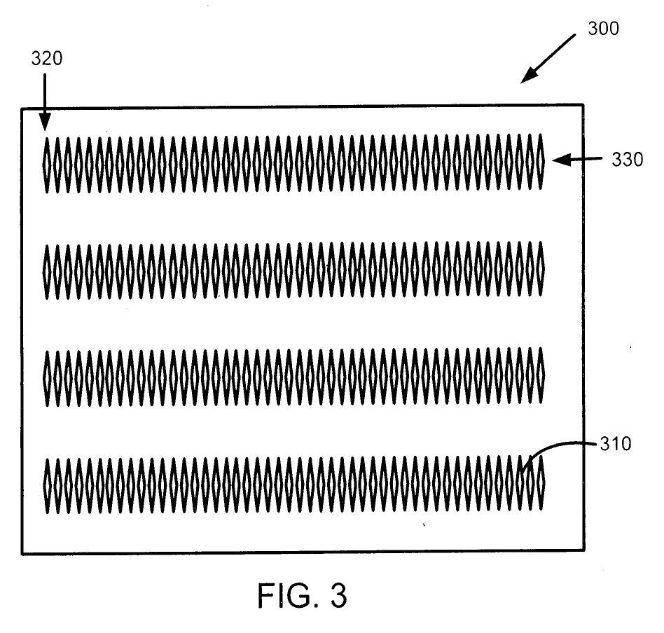

The layered image effect or moiré pattern is created by the combination of a lenticular lens or other light steering device (barrier screen, fisheye lens, and the like) having elongated parallel light steering optical elements coupled with distorted pattern elements. For example, an exemplary raw image sheet 300 is depicted in FIG. 3. Raw image sheet 300 has a plurality of distorted pattern elements 310 arranged in a plurality of columns 320. The moiré pattern generation is one application of the science of interferometry (as utilized in the graphic arts' industry), giving optic images the effect of relief, viewed either through transparency or by reflection. Raw image sheet 300 in combination with a lenticular lens sheet may result in the background image depicted in FIG. 2, as background pattern 210. The production of the raw image sheet may be a difficult process often requiring precision equipment to achieve a desired result. Thus, it may be desirable to have pre-printed sheets having a raw image moiré pattern printed thereon and supplied.

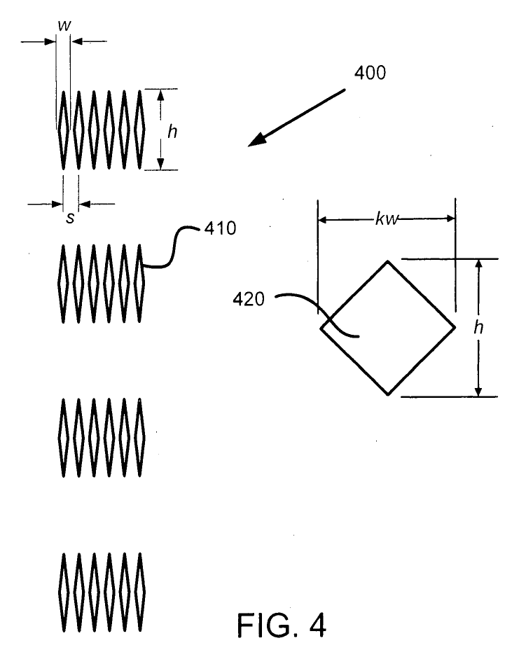

Referring now to FIG. 4, an exemplary raw image pattern 400 is depicted. Raw image pattern 400 includes a plurality of distorted pattern elements 410. Each of the distorted pattern elements has a height h which is the height of the resultant pattern element 420 when viewed under a lenticular lens. The width w is distorted from the resultant pattern element 420 width kw, where k is a constant factor typically, but not limited to, on the order of tens or hundreds. Thus, the width of resultant pattern element 420 may be said to be distorted or squeezed in the width direction to have a distorted pattern element 410 width w. In an exemplary embodiment, the width w may be approximately the same width as a single lenticule. The resultant moiré pattern may then be a plurality of pattern elements 420 distributed over a surface but appearing in the background. Referring again to FIG. 2 it may often be desirable to have a customized or personalized focal image such as image 220 which interrupts the pattern. In accordance with an exemplary embodiment the pattern is not necessarily a repeating pattern but may be a pattern which changes or morphs through the display sheet.

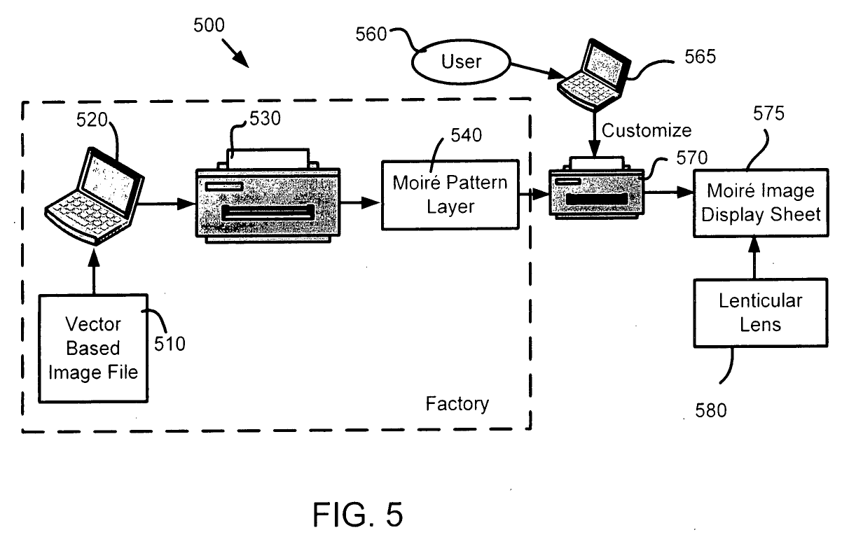

Referring now to FIG. 5, a system 500 is depicted for producing a customized or personalized moiré pattern display sheet. The customized or personalized moiré pattern display sheet includes a first layer having a printed pattern. The pattern includes a series of visual elements that are aligned and have been distorted at least in a first direction as depicted in FIGS. 3 and 4. The series of visual elements is generated from an electronically saved image file 510. File 510 is preferably utilized and/or generated by a computer 520 or other processing device. File 510 is then used to generate printing commands sent to a printer 530 which prints the moiré pattern 540 on a substrate. In accordance with alternative embodiments, the moiré pattern 540 may be produced by any of a variety of techniques, including but not limited to printing, adhering, molding, photographic processing, etching, etc. Once the raw image moiré pattern has been produced, the sheet may then be customized or personalized by any of a variety of means, including but not limited to adhering a design thereto, handwriting an image, printing an image, etc. For example, as depicted a computer 365 may generate an image by a user 550. The customized output is printed on sheet 540 by a printer 570. A lenticular lens 580 is then positioned over the customized sheet 575 to produce a customized image with a depth effect. A light steering optical layer 588 is not limited to a lenticular lens 550 but may be a variety of optical elements. The light steering optical layer comprises a plurality of optical features which change the direction of the light and thereby provides a depth effect of the series of visual elements combined with the customized image to a viewer looking through the light steering optical layer. Thus, a customized moiré image display sheet is produced. Alternatively, there may be one or more moiré patterns printed in various ways, including but not limited to at different angles, in different rows, with different frequency, etc. By having multiple moiré patterns, it may be possible to view them using different lenses or by changing the orientation of a lens.

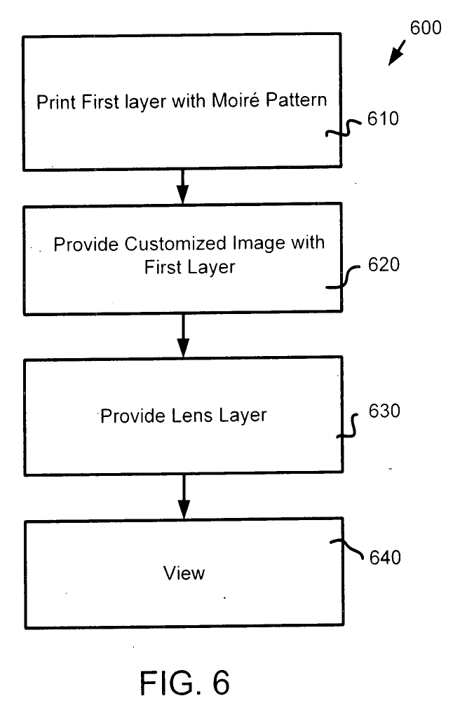

Referring now to FIG. 6, a process 600 of forming a customized moiré pattern display sheet is depicted. The process starts by generating an image file having a series of visual elements and printing a sheet with the raw moiré image pattern (process 610). Next, the raw image is customized with a customized focal image by adhering the image to the sheet, handwriting the image to the sheet, printing the image on the sheet, placing the image on the sheet or doing one of these actions to the lenticular display sheet (process 620). The light steering optical layer such as but not limited to a lenticular lens is provided to overlay the first layer (process 630). The light steering optical layer includes a plurality of optical features which change the direction of the light and thereby provide a depth effect of the visual elements to a viewer looking through the light steering optical layer. Any of a variety of optical elements may be used including but not limited to barrier screen, and fisheye lenses, among others.

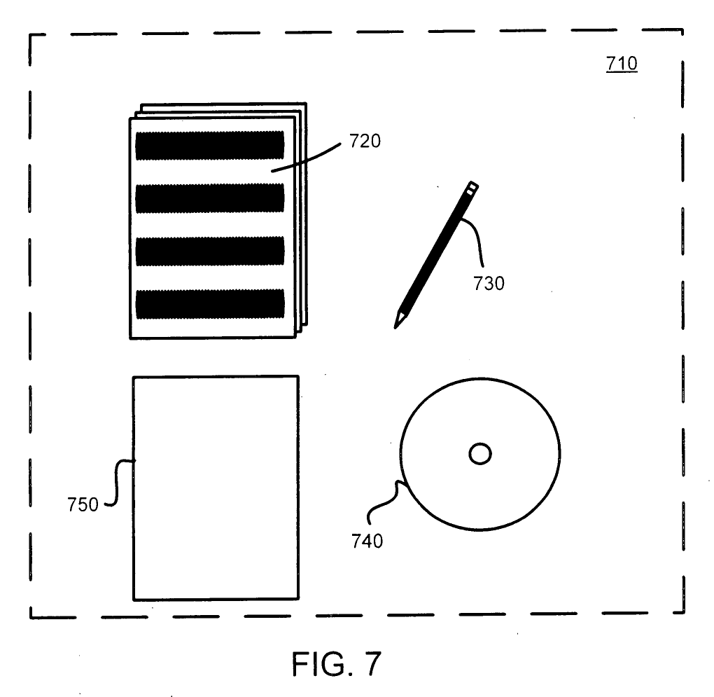

Referring now to FIG. 7, a depth effect customization kit 710, which is used for creating personalized or customized materials having a personalized or customized image with a depth effect, is depicted. Kit 710 includes one or more substrates, including but not limited to sheets of paper 720 of a paper pad or the like. Each of sheets 720 is preferably pre-printed with a raw moiré image pattern. Alternatively, kit 710 may include access to software (included or with instructions to access over a communication network) which allows a user to print one or more selected raw moiré image patterns on sheets 720. Also, kit 720 includes a means by which a user is able to apply their own customized or personalized image. Such a means may be of any of a variety of forms including but not limited to a pen 730, computer software on a storage disc 740 or other storage device or access to a storage device having templates, instructions, drivers, or applications for creating and/or printing a customized or personalized image on one or more sheets 720. Other means include adhesives, stickers, paints or other marking devices, solids, or fluids, cut-outs, stencils, appliqués, printers, printing inks, stamps, burning or heating devices, as well as substrates such as paper 720 which are able to accept any of such markings or imaging. Kit 710 may be used to make any of a number of customized or personalized items displaying a depth effect when coupled with a lens 750. The use of lens 750 produces the depth effect as described above when combined with the raw moiré image pattern and the customized image. Items created with kit 720 may include but are not limited to greeting cards, invitations, business cards, gift cards, works of art, notebook sheets, notepads, scrap booking pages or scrap booking items, picture frames, ring binder pages, ring binder covers, presentation covers, etc.

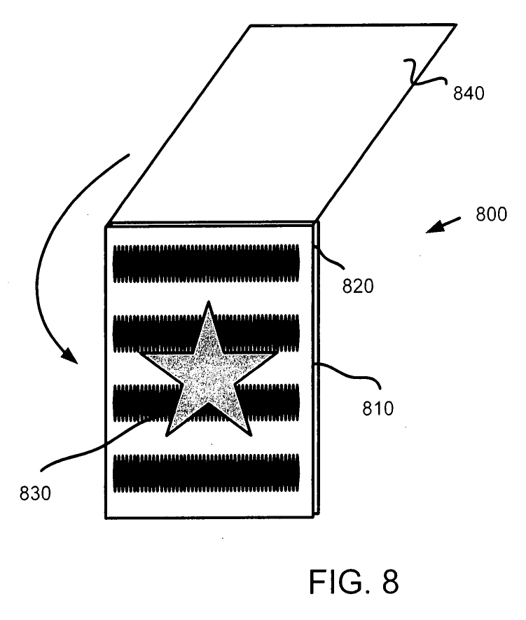

Referring now to FIG. 8, an exemplary application of the described technology is depicted. FIG. 8 depicts a notepad 800 having a plurality of pages 810 one or more of which is preprinted with a raw moiré pattern image 820. In use, a user writes, types, prints, or otherwise disposes an image 830 onto a notepad sheet 810. A cover 840 may comprise or otherwise contain a lenticular lens sheet or other applicable optical steering element. A user therefore flips cover 840 to overlay sheet 810. Once the sheet with the lenticular lens overlays sheet 810, a viewer may see image 830 having an effect of depth where image 830 appears to be detached or on a separate plane from the rest of the graphic display. Alternatively, image 830 may appear in either the background or in the foreground.

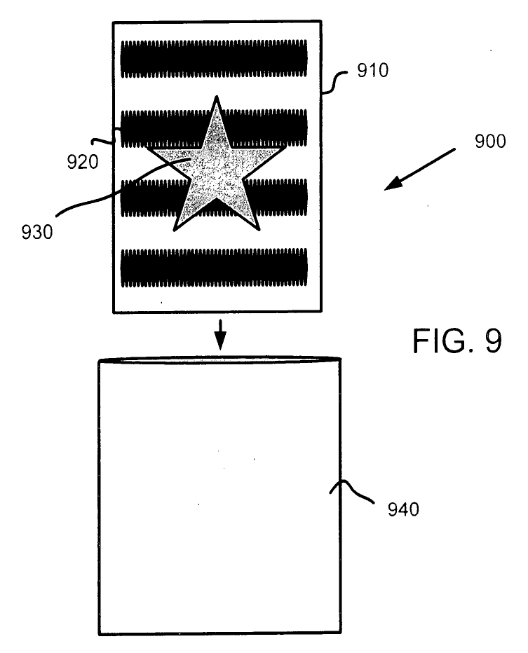

Referring now to FIG. 9, another exemplary application of the described technology is depicted. FIG. 9 depicts a card/sleeve system 900 having at least one pre-printed card 910 which is preprinted with a raw moiré pattern image 920. In use, a user writes, types, prints, or otherwise disposes an image 930 onto a card 910. Once the images have been completed, a user simply slips card 910 into a sleeve 940 which may include a lenticular lens sheet or other applicable optical steering element at least on the face of sleeve 940. After card 910 is slipped into sleeve 940, a viewer may observe image 930 having an effect of depth where image 930 appears either in the background or in the foreground. Such card with a sleeve may have innumerable uses including, but not limited to business cards, gift cards, greeting cards, note cards, luggage tags, etc. System 900 is easily scalable to larger sizes which may be used for flyers, bulletin board posters, advertisements, sheet protection for any use, envelopes, product displays, etc.

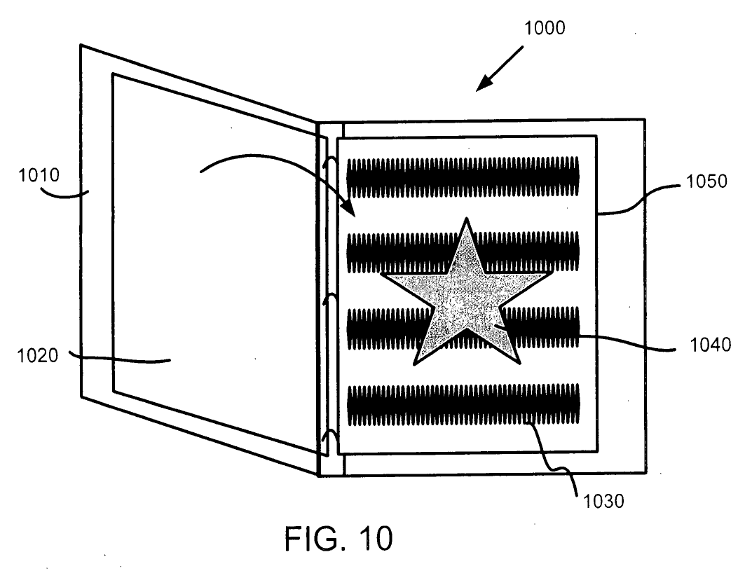

Referring now to FIG. 10, a further exemplary application of the described technology is depicted. FIG. 10 depicts a binder, such as but not limited to a three ring binder 1000 having a cover 1010 and a plurality of preferably insertable/removable pages 1050 one or more of which is preprinted with a raw moiré pattern image 1030. In use, a user writes, types, prints, or otherwise disposes an image 1040 onto an insertable/removable sheet 1020. Another insertable/removable sheet 1050 may be positioned to overlay sheet 1020. Sheet 1050 comprises at least partially a lenticular lens or other light steering device. Once sheet 1050 with the lenticular lens overlays sheet 1020, a viewer may see image 1040 having an effect of depth where image 1040 appears either on a different plane from other parts of the graphic display. In an exemplary embodiment, sheets 1050 may be interchanged in which lenses with different characteristics (color, density, curvature, thickness, etc.) may be used each providing a different depth effect. Alternatively, multiple pre-printed raw moiré images may be included on a single sheet in which only specific moiré patterns may be seen by an observer dependent upon the characteristics of the lens sheet being used.

While the detailed drawings, specific examples, and particular formulations given described exemplary embodiments, they serve the purpose of illustration only. It should be understood that various alternatives to the embodiments of the invention described may be employed in practicing the invention. It is intended that the following claims define the scope of the invention and that structures within the scope of these claims and their equivalents be covered thereby. The configurations and processes shown and described may differ depending on the chosen performance characteristics and physical characteristics of the display. For example, the configuration and/or process used may be dictated, at least in part, by the desired cost. Also, the depth effect desired may dictate the configuration and/or process used. The systems shown and described are not limited to the precise details and conditions disclosed. Method steps provided may not be limited to the order in which they are listed but may be ordered any way as to carry out the inventive process without departing from the scope of the invention. Furthermore, other substitutions, modifications, changes and omissions may be made in the design, operating conditions and arrangements of the exemplary embodiments without departing from the scope of the invention as expressed in the appended claims.

What is claimed is:

1. A personalized image with a depth effect, comprising:
a first layer having a pre-manufactured moiré pattern printed thereon, the pre-manufactured moiré pattern comprising a series of pattern elements at least some of which have been distorted at least in a first direction;
a customized or personalized image that is at least one of coupled to, overlying, or underlying the first layer; and
a light steering optical layer overlying the first layer, the light steering optical layer comprising a plurality of optical features which change the direction of the light and thereby provide a depth effect of the customized or personalized image and a pattern image.

2. The image of claim 1, wherein the customized or personalized image is at least partially printed on the first layer.

3. The image of claim 1, wherein the customized or personalized image is at least partially adhered to the first layer.

4. The image of claim 1, wherein the customized or personalized image is at least partially handwritten on the first layer.

5. The image of claim 1, wherein the first layer comprises an organic surface.

6. The image of claim 1, wherein the first layer comprises a synthetic surface.

7. The image of claim 1, wherein the first layer comprises a foil surface.

8. The image of claim 1, wherein the first layer comprises a film surface.

9. The image of claim 1, wherein the first layer comprises a glass surface.

10. The image of claim 1, wherein the light steering optical layer comprises a lens sheet.

11. The image of claim 1, wherein the light steering optical layer comprises a barrier screen.

12. The image of claim 1, wherein the light steering optical layer comprises a lenticular lens.

13. The image of claim 1, wherein the light steering optical layer comprises a cover sheet.

14. The image of claim 1, wherein the light steering optical layer comprises a sleeve.

15. The image of claim 1, wherein the light steering optical layer comprises a pocket.

16. The image of claim 1, wherein the first layer comprises a curved surface.

17. The image of claim 1, wherein the first layer comprises a printed layer on a surface of the light steering optical layer.

18. The image of claim 1, wherein the printed layer is printed on the backside of the light steering optical layer.

19. A method of customizing an image having a depth effect, comprising:
producing a first layer with a moiré pattern, the moiré pattern comprising a series of pattern elements that have been distorted at least in a first direction;
providing a customized or personalized image to at least one of overlie, underlie, or couple to the first layer;
providing a light steering optical layer overlying the customized or personalized image, the light steering optical layer comprising a plurality of optical features which change the direction of the light and thereby provide a depth effect of the customized or personalized image and a pattern image.

20. The method of claim 19, further comprising:
printing the customized or personalized image at least partially on the first layer.

21. The method of claim 19, further comprising:
adhering the customized or personalized image at least partially to the first layer.

22. The method of claim 19, further comprising:
writing the customized or personalized image at least partially on the first layer.

23. The method of claim 19, wherein the first layer comprises an organic surface.

24. The method of claim 19, wherein the first layer comprises a synthetic surface.

25. The method of claim 19, wherein the first layer comprises a foil surface.

26. The method of claim 19, wherein the first layer comprises a film surface.

27. The method of claim 19, wherein the first layer comprises a glass surface.

28. The method of claim 19, wherein the light steering optical layer comprises a lens sheet.

29. The method of claim 19, wherein the light steering optical layer comprises a barrier screen.

30. The method of claim 19, wherein the light steering optical layer comprises a lenticular lens.

31. The method of claim 19, wherein the light steering optical layer comprises a cover sheet.

32. The method of claim 19, wherein the light steering optical layer comprises a sleeve.

33. The method of claim 19, wherein the first layer comprises a curved surface.

34. The method of claim 19, further comprising:
folding the light steering optical layer over the first layer.

35. The method of claim 19, wherein the first layer comprises a printed layer on a surface of the light steering optical layer.

36. The method of claim 35, wherein the printed layer is printed on the backside of the light steering optical layer.

37. A depth effect customization kit comprising:
a first layer having a pre-manufactured moiré pattern printed thereon, the pre-manufactured moiré pattern comprising a series of pattern elements that have been distorted at least in a first direction;
a means to provide a customized or personalized image that is at least one of coupled to, overlying, or underlying the first layer; and
a light steering optical layer overlying the first layer, the light steering optical layer comprising a plurality of optical features which change the direction of the light and thereby provide a depth effect of the customized or personalized image and a pattern image.

38. The kit of claim 37, wherein the kit is a business card making kit.

39. The kit of claim 37, wherein the kit is a greeting card making kit.

40. The kit of claim 37, wherein the kit is an invitation making kit.

41. The kit of claim 37, wherein the kit is a scrap booking kit.

42. The kit of claim 37, wherein the kit is a presentation binder making kit.

43. The kit of claim 37, wherein the means comprises a marking apparatus.

44. The kit of claim 37, wherein the means comprises printer-ready sheets.

45. The kit of claim 37, wherein the means comprises computer software.

46. The kit of claim 37, wherein the first layer comprises a curved surface.

47. The kit of claim 37, wherein the first layer comprises a printed layer on a surface of the light steering optical layer.

48. The kit of claim 47, wherein the printed layer is printed on the backside of the light steering optical layer.
